(19) United States
(12) Patent Application Publication
(10) Pub. No.: US 2004/0167841 A1
(43) Pub. Date: Aug. 26, 2004

(54) Strategic business tool and method for financial institutions

(76) Inventor: John Richard Segerstrom, Lake Oswego, OR (US)

Correspondence Address: KOLISCH HARTWELL, P.C., 520 S.W. YAMHILL STREET, SUITE 200, PORTLAND, OR, 97204, US

(21) Appl. No.: 10/742,698

(22) Filed: Dec. 19, 2003

Related U.S. Application Data
(60) Provisional application No. 60/436,337, filed on Dec. 23, 2002.
(60) Provisional application No. 60/436,338, filed on Dec. 23, 2002.

(51) Int. Cl. G06F 17/60

(52) U.S. Cl. 705/35; 705/7

(57) ABSTRACT

A strategic business method for financial institutions includes the steps of establishing a strategic metric, setting measurable goals using the established strategic metric, communicating the goals effectively, and measuring and reporting progress in reaching the goals. A strategic business tool for financial institutions includes structure for establishing a strategic metric, structure for setting measurable goals using the established strategic metric, structure for communicating the goals effectively, and structure for measuring and reporting progress in reaching the goals.

### CROSS-REFERENCE TO RELATED APPLICATIONS

This application claims priority to U.S. Provisional Patent Application Serial No. 60/436,337, filed Dec. 23, 2002 and entitled “Strategic Business Tool and Method for Financial Institutions” and U.S. Provisional Patent Application Serial No. 60/436,338, filed Dec. 23, 2002 and entitled “Strategic Business Tool and Method for Financial Institutions”.

### BACKGROUND AND SUMMARY OF INVENTION

The practice of Strategic Management, part of which is “strategic planning”, is today an open circuit: because there is no strategic metric, there is no way to set measurable goals, communicate them meaningfully, and then measure and report progress in reaching them. There can be no control or refinement of individual activities (the building blocks of a strategy). Resource allocation is based on experience, interpretation and luck. In every case, the Bank has two strategies: (1) the TARGET STRATEGY of the governing body and management and (2) the ACTUAL STRATEGY resulting from the sum of individual activities actually being undertaken in the organization.

The invention described below in the specification, figures and attachment may be characterized as a strategic business method for financial institutions. The method includes the steps of establishing a strategic metric, setting measurable goals using the established strategic metric, communicating the goals effectively, and measuring and reporting progress in reaching the goals. The invention may also be thought of as a strategic business tool for financial institutions that includes structure for establishing a strategic metric, structure for setting measurable goals using the established strategic metric, structure for communicating the goals effectively, and structure for measuring and reporting progress in reaching the goals. The structure is preferably in the form of software that is described further below.

Michael Porter (Harvard Business School) has proposed a strategic “common denominator” as a basic dimension of strategy: DIFFERENTIATION (“Value”)<STRATEGY<EFFICIENCY (“Price”).

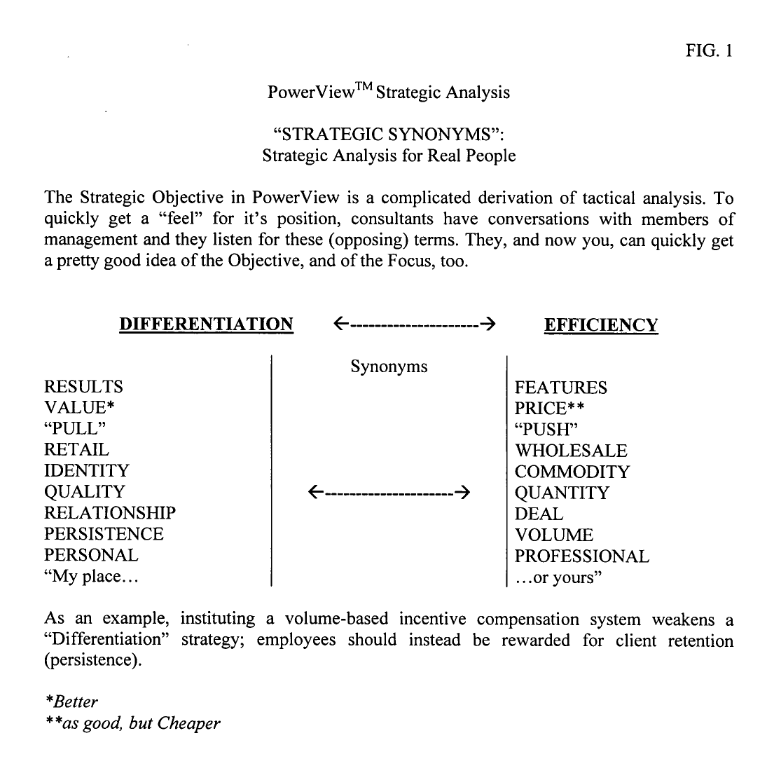

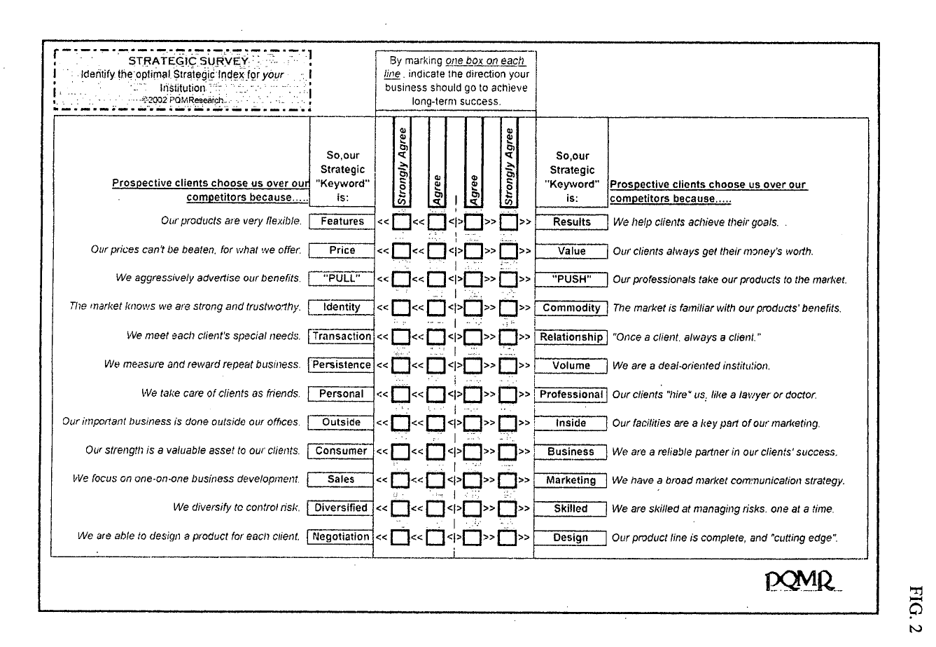

Job#1: Translate Board/Management expertise and factual knowledge onto Porter's dimension. (a) PQMR proposes “synonyms” for the Porter dimension's end points. (FIG. 1); (b) The PQMR Strategic Survey (FIG. 2) uses these opposing concepts to facilitate conversation by the responsible governing body about strategy, on Porter's dimension; (c) The completed Strategic Survey is scored to estimate the strategic position implied by the goals of the planning body: a survey score of “0” implies a pure “Value” strategy, and “100” implies “Price”; (d) The survey also scores “Internal Focus”, defined here as the internal consistency of responses to the Survey's strategic dimensions, by individual participants and by the group in total. The goal of the ensuing discussion is to maximize “Internal Focus” at a particular combined “Target Strategy” score. This “Target Strategy” is the first of the Bank's two strategies.

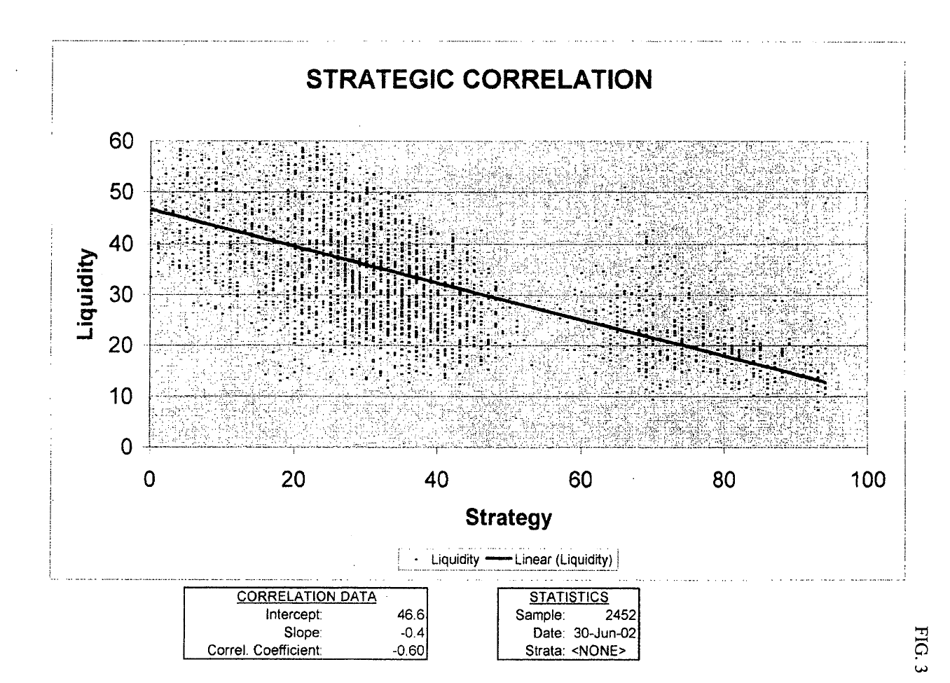

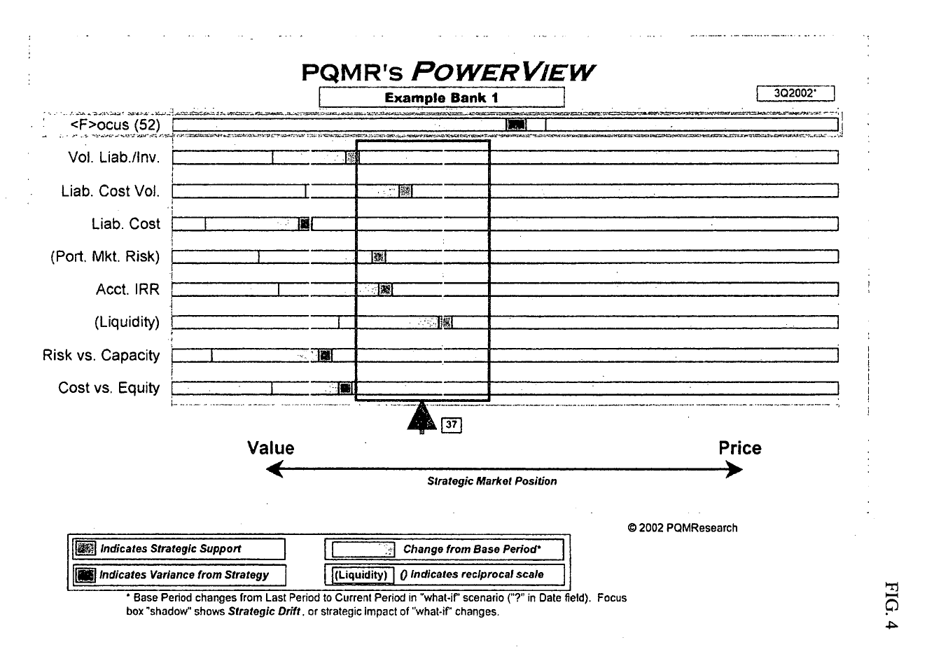

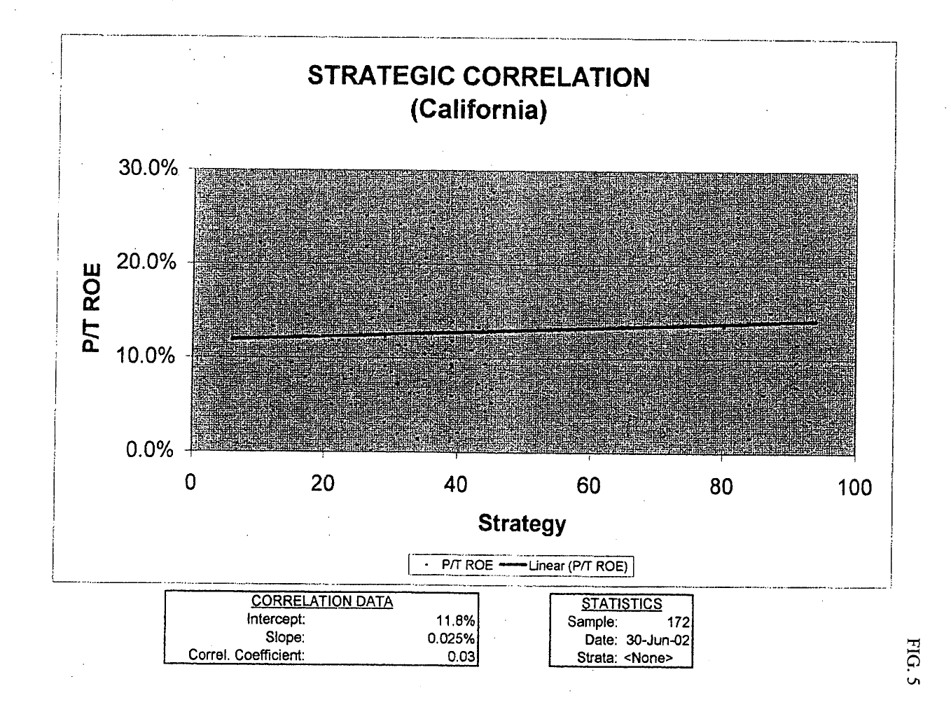

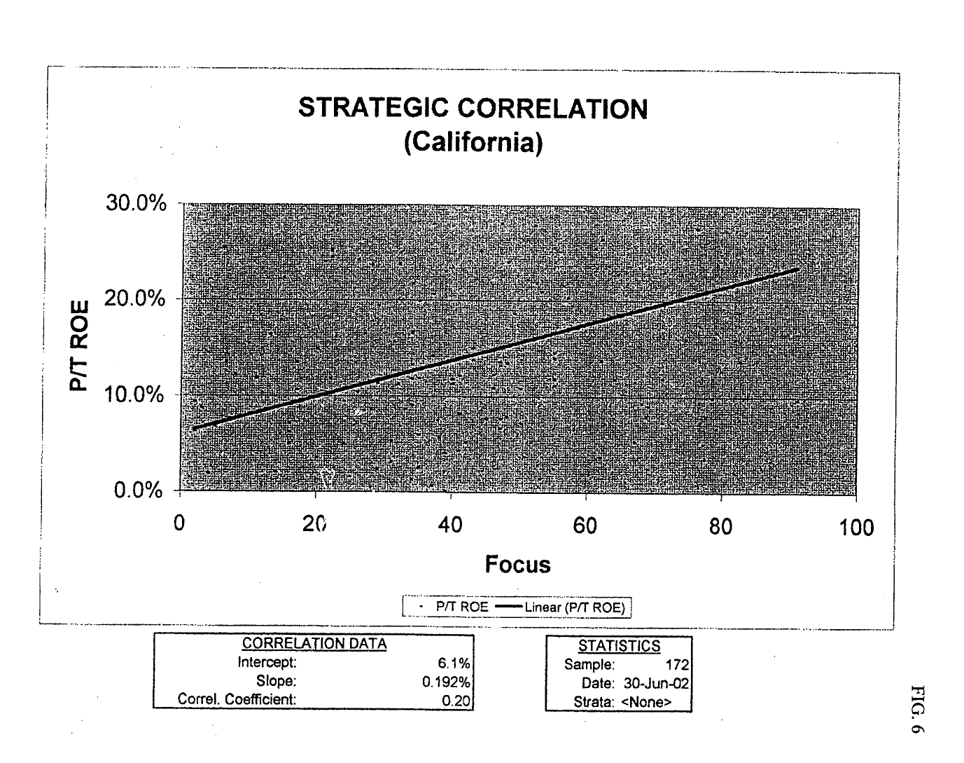

Job #2: Measure the second of the Bank's two strategies: the “Actual Strategy”. (a) Each of the activities making up the “Actual Strategy” leaves telltale footprints (for example, lower Liquidity, defined as liquid assets divided by total assets, arises from pursuit of a “Price” strategy. FIG. 3 confirms this using actual data from over 5,000 US banks); (b) PowerView measures such footprints, translates them into tactical measures and infers the “Actual Strategy” that they represent, when viewed together (FIG. 4). There are no good or bad strategies (FIG. 5 shows no significant correlation between “Actual Strategy” and profitability among California banks, for example), but adopting a clear strategy is a critical key to success: a clear goal for the various tactics is essential if they are to be aligned to achieve that goal; (c) PowerView also evaluates how the tactical activity measures are aligned behind the “Actual Strategy”, and assigns a “Calculated Focus” score: how well, on average, do individual tactics support the overall strategy. This is compared to the Strategic Survey's “Internal Focus”: aligned tactics (a high “Calculated Focus”) is the critical determinant of financial success (FIG. 6).

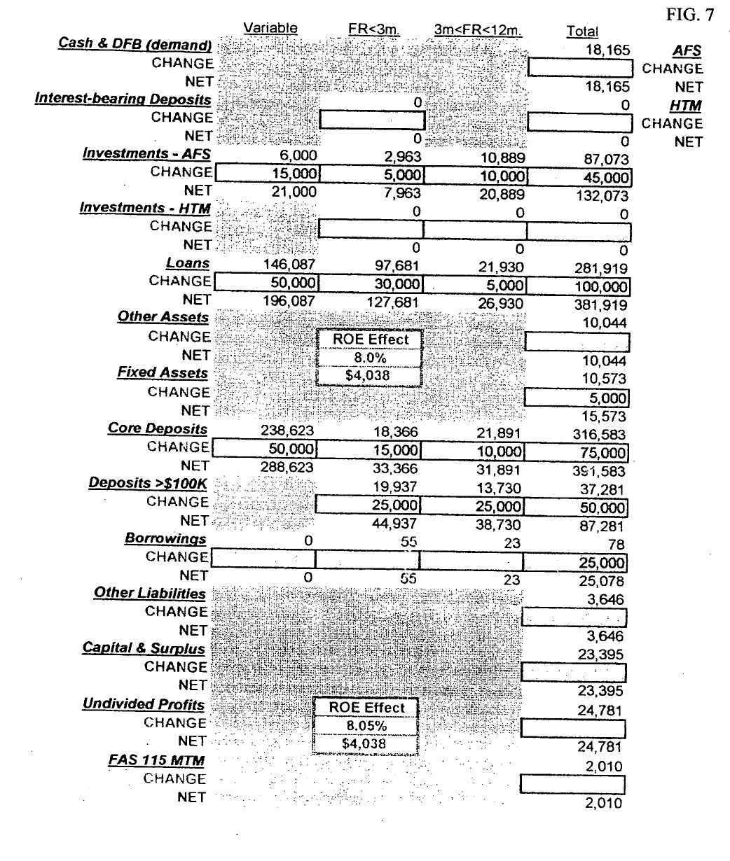

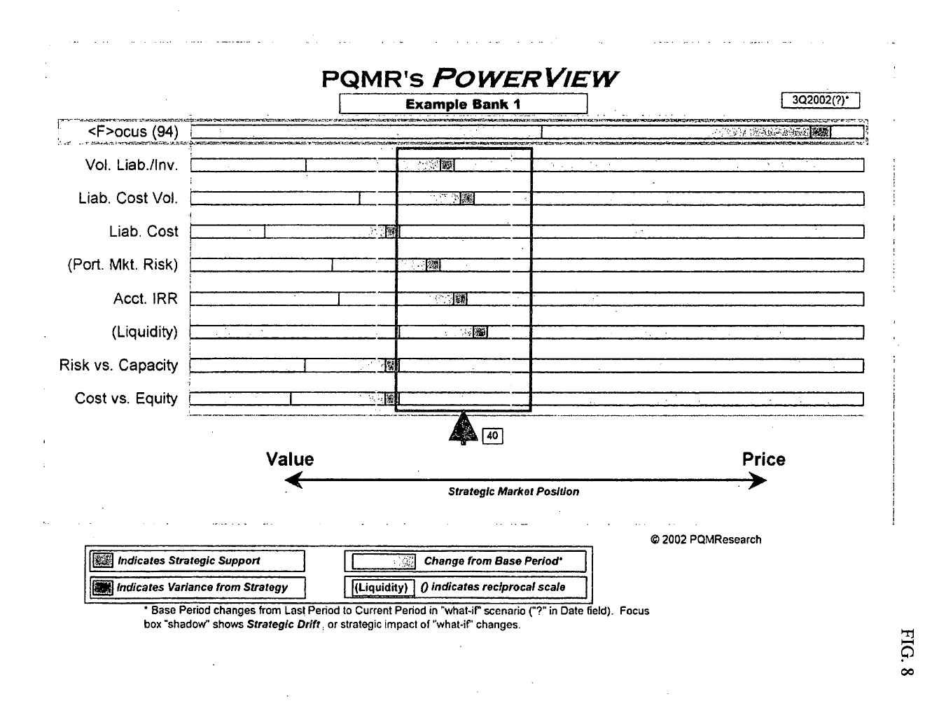

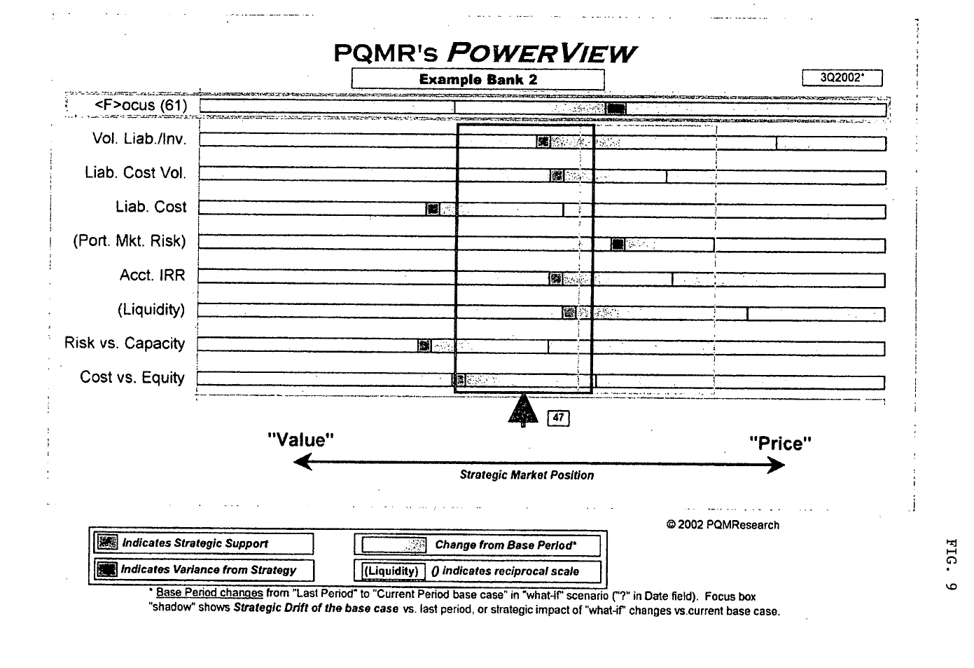

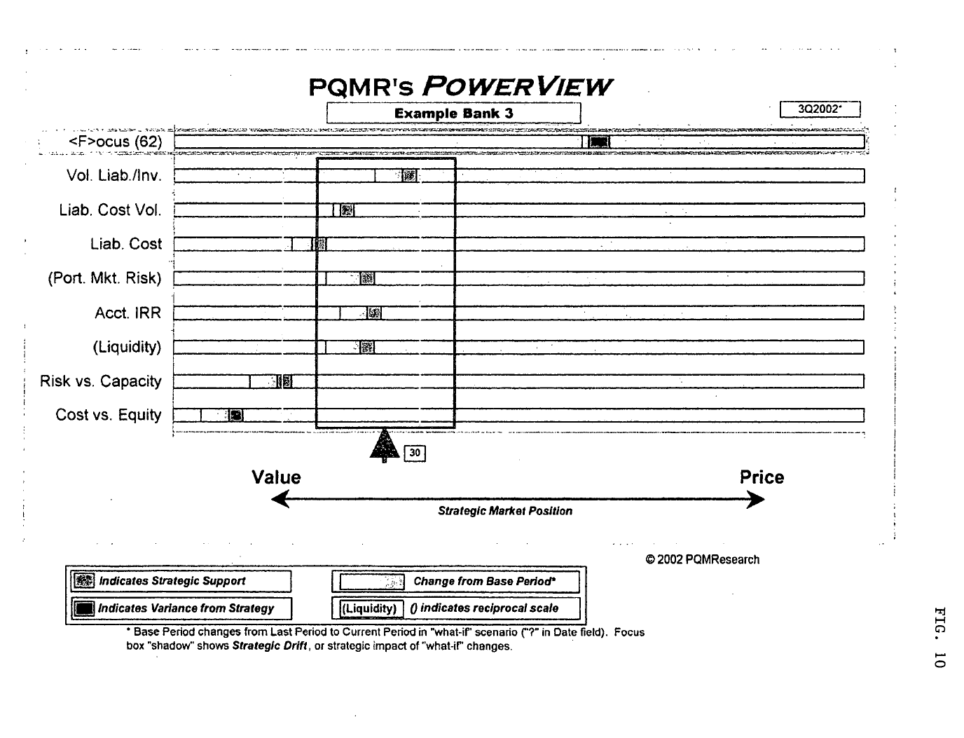

Job#3: The “Strategic Plan”: The strategic plan sets forth steps to adjust individual Bank activities to: (a) Conform the “Actual Strategy” to the “Target Strategy”; (b) Maximize the “Calculated Focus” score; (c) PowerView's “what-if ” capability allows exploration of strategic alternatives, and selection of the best path to (a) and (b), from an ease of implementation and market opportunity standpoint (FIG. 7, resulting in FIG. 8); (d) The PowerView structure allows communication of tactical goals, based on the “Target Strategy”, throughout the organization, in common terms brought to the individual department, and even the individual employee level.

PowerView provides a tool to measure progress toward achieving the “Strategic Plan's” objectives. Every six months, management and the board receive an objective measure of “Actual Strategy” and “Calculated Focus” (FIG. 4), and can clearly see successes to celebrate, and failures requiring management attention. Annually, the “Strategic Plan” itself can be re-examined by all stakeholders, again in common terms. Thus, PowerView for the first time allows the “Strategic Management” cycle to be complete.

I claim:

1. A strategic business method for financial institutions, comprising:
establishing a strategic metric;
setting measurable goals using the established strategic metric;
communicating the goals effectively; and
measuring and reporting progress in reaching the goals.

2. A strategic business tool for financial institutions, comprising:
structure for establishing a strategic metric;
structure for setting measurable goals using the established strategic metric;
structure for communicating the goals effectively; and
structure for measuring and reporting progress in reaching the goals.
